(19) United States
(12) Patent Application Publication
(10) Pub. No.: US 2025/0021829 A1
(43) Pub. Date: Jan. 16, 2025

(54) Method and Apparatus for Simulating Deployment for AI Model

(71) Applicant: Siemens Aktiengesellschaft, München (DE)

(72) Inventors: Tao Fei, Shanghai (CN); Edison de Faria Siqueira, Nürnberg (DE); Rafael Anicet Zanini, Nürnberg (DE); Hai Feng Wang, Shanghai (CN); Fei Juang Hu, Shanghai (CN)

(73) Assignee: Siemens Aktiengesellschaft, München (DE)

(21) Appl. No.: 18/713,792

(22) PCT Filed: Nov. 29, 2021
(86) PCT No.: PCT/CN2021/134078

§ 371 Date: May 28, 2024

(51) Int. Cl. G06N 3/10

(52) U.S. Cl. CPC G06N 3/10

(57) ABSTRACT

Various embodiments include methods for simulating deployment for an artificial intelligence (AI) model. An example method includes: determining at least two formats of an AI model; determining runtimes corresponding to the AI model in the at least two formats; combining a preset simulation environment with the at least two runtimes to obtain at least two combinations; running the at least two combinations to obtain corresponding data flow results; and determining one combination from the at least two combinations according to the data flow results.

### CROSS-REFERENCE TO RELATED APPLICATIONS

This application is a U.S. National Stage Application of International Application No. PCT/CN2021/134078 filed Nov. 29, 2021, which designates the United States of America, the contents of which are hereby incorporated by reference in their entirety.

### TECHNICAL FIELD

The present disclosure relates to artificial intelligence (AI). Various embodiments of the teachings herein include methods and/or apparatus for simulating deployment for an AI model.

### BACKGROUND

Currently, on-site deployment is one of core issues of applying AI to factories. Different AI models have different working modes and applicable industrial devices. Even with great knowledge of automation applications, factory engineers are not very familiar with how to deploy different AI models to computing devices in factories, specifically, whether an AI model is applicable to an existing automation application, and what impact the AI model may have on an existing automation system. Moreover, computing devices in factories often have limited computing power, and it is not very likely to directly apply a variety of different AI models.

In addition, when designing an entire system, engineers generally need to evaluate related appropriate hardware before starting to make on-site deployment in practice. Such evaluation usually takes a lot of time especially when there are hundreds or even tens of thousands of similar machines or production lines. To appropriately apply an AI model to on-site deployment, the engineers need to find related a specific AI model and an AI runtime and a specific computing device, to find an appropriate matching combination. However, how to find a corresponding appropriate matching combination quickly and effectively is still a problem to be resolved.

### SUMMARY

To resolve the foregoing technical problems, the teachings of the present disclosure include methods and apparatus for simulating deployment for an AI model to help factory engineers optimize on-site deployment and find a combination of an AI model, an AI runtime, and a computing device that better meets user requirements. For example, some embodiments of the teachings herein include a method for simulating deployment for an artificial intelligence (AI) model, the method comprising: determining (110) at least two formats of an AI model; determining (120) runtimes corresponding to the AI model in the at least two formats; combining (150) a preset simulation environment with the at least two runtimes to obtain at least two combinations; running (160) the at least two combinations to obtain corresponding data flow results; and determining (170) one combination from the at least two combinations according to the data flow results.

In some embodiments, determining at least two formats of an AI model comprises converting a format of the AI model when at least one runtime is unable to run the format of the AI model, to obtain the at least two formats of the AI model.

In some embodiments, before the combining a preset simulation environment with at least two runtimes, the method further comprises after an actual computing device of a user is virtualized, mounting the virtualized computing device to the preset simulation environment.

As another example, some embodiments include a method for simulating deployment for an artificial intelligence (AI) model, the method comprising: determining (210) at least one format of an AI model; determining (220) a runtime corresponding to the AI model in the at least one format; combining (230) at least two simulation environments with the at least one runtime to obtain at least two combinations; running (240) the at least two combinations to obtain corresponding data flow results; and determining (250) one combination from the at least two combinations according to the data flow results.

In some embodiments, the determining one combination from the at least two combinations according to the data flow results comprises determining the one combination from the at least two combinations according to a preset sorting rule of the data flow results.

In some embodiments, the determining one combination from the at least two combinations according to the data flow results comprises determining the one combination from the at least two combinations according to a data flow result selected by a user.

In some embodiments, the simulation environments comprise at least one of the following: a central processing unit (CPU) or a graphic processing unit (GPU).

As another example, some embodiments include a method for simulating deployment for an artificial intelligence (AI) model, the method comprising: determining (310) a plurality of preset formats of an AI model; determining (320) a first runtime corresponding to the AI model in a first preset format in the plurality of preset formats; performing (330) a combination of a preset simulation environment and the first runtime; running (340) the combination to obtain a first data flow result; if the first data flow result meets a preset condition, outputting (350) the combination; if the first data flow result does not meet the preset condition, determining (360) a second runtime corresponding to the AI model in a second preset format in the plurality of preset formats; performing (370) a combination of the preset simulation environment and the second runtime; and running (380) the combination to obtain a second data flow result; if the second data flow result meets the preset condition, outputting (390) the combination; and if the second data flow result does not meet the preset condition, repeating the process until a data flow result meets the preset condition, and outputting (391) a combination corresponding to the data flow result.

As another example, some embodiments include an apparatus (40) for simulating deployment for an artificial intelligence (AI) model, the apparatus comprising: a converter (41), configured to determine at least two formats of an AI model; a runtime manager (42), configured to determine a runtime corresponding to the AI model in the at least one format; a computing device manager (46), configured to manage simulation environments; a combinator (43), configured to combine at least two simulation environments with at least one runtime to obtain at least two combinations; a profiler (44), configured to run the at least two combinations to obtain corresponding data flow results; and a deployer (45), configured to determine one combination from the at least two combinations according to the data flow results.

As another example, some embodiments include an electronic device (500), comprising a processor (510), a memory (520), and instructions stored in the memory (520), wherein the instructions are executed by the processor (510) to perform one or more of the methods described herein.

As another example, some embodiments include a computer-readable storage medium, storing computer instructions, wherein the computer instructions, when run, perform one or more of the methods described herein.

### BRIEF DESCRIPTION OF THE DRAWINGS

The following accompanying drawings are only intended to exemplarily illustrate and explain the teachings of the present disclosure, but do not limit the scope of the present disclosure. In the drawings:

FIG. 1 is a flowchart of an example method for simulating deployment for an AI model incorporating teachings of the present disclosure;

FIG. 2 is a flowchart of an example method for simulating deployment for an AI model incorporating teachings of the present disclosure;

FIG. 3 is a flowchart of an example method for simulating deployment for an AI model incorporating teachings of the present disclosure;

FIG. 4 is a schematic diagram of an example apparatus for simulating deployment for an AI model incorporating teachings of the present disclosure; and

FIG. 5 is a schematic diagram of an example electronic device incorporating teachings of the present disclosure.

### DESCRIPTIONS OF REFERENCE NUMERALS

100, 200, and 300: method for simulating deployment for an AI model 110-170, 210-250, and 310-391: method steps
40: apparatus for simulating deployment for an AI model 41: converter
42: runtime manager
43: combinator 44: profiler 45: deployer 46: computing device manager
47: monitor
500: electronic device 510: processor 520: memory

### DETAILED DESCRIPTION

The present disclosure describes apparatus and methods for simulating deployment for an AI model. An example method includes: determining at least two formats of an AI model; determining runtimes corresponding to the AI model in the at least two formats; combining a preset simulation environment with at least two runtimes to obtain at least two combinations; running the at least two combinations to obtain corresponding data flow results; and determining one combination from the at least two combinations according to the data flow results. By combining a preset simulation environment with a plurality of runtimes and an AI model in corresponding formats, according to corresponding data flow results, a better combination is provided to a user, to help the user quickly and effectively complete simulated deployment for the AI model.

Another example embodiments includes: determining at least one format of an AI model; determining a runtime corresponding to the AI model in the at least one format; combining at least two simulation environments with at least one runtime to obtain at least two combinations; running the at least two combinations to obtain corresponding data flow results; and determining one combination from the at least two combinations according to the data flow results. By combining a plurality of simulation environments with at least one runtime and an AI model in a corresponding format, according to corresponding data flow results, a better combination is provided to the user, to help the user quickly and effectively complete simulated deployment for the AI model.

Another example method includes: determining a plurality of preset formats of an AI model; determining a first runtime corresponding to the AI model in a first preset format in the plurality of preset formats; performing a combination of a preset simulation environment and the first runtime; running the combination to obtain a first data flow result; if the first data flow result meets a preset condition, outputting the combination; if the first data flow result does not meet the preset condition, determining a second runtime corresponding to the AI model in a second preset format in the plurality of preset formats; then performing a combination of the preset simulation environment and the second runtime; and running the combination to obtain a second data flow result; if the second data flow result meets the preset condition, outputting the combination; and if the second data flow result does not meet the preset condition, repeating the process until a data flow result meets the preset condition, and outputting a combination corresponding to the data flow result. By combining a preset simulation environment with runtimes in different preset formats and an AI model in corresponding formats one by one, until after a corresponding data flow result meets a preset condition, a better combination is provided to the user, to help the user quickly and effectively complete simulated deployment for the AI model.

An example apparatus for simulating deployment for an AI model includes: a converter, configured to determine at least two formats of an AI model; a runtime manager, configured to determine a runtime corresponding to the AI model in the at least one format; a computing device manager, configured to manage simulation environments; a combinator, configured to combine at least two simulation environments with at least one runtime to obtain at least two combinations; a profiler, configured to run the at least two combinations to obtain corresponding data flow results; and a deployer, configured to determine one combination from the at least two combinations according to the data flow results.

Another embodiment of the teachings herein includes an electronic device, with a processor, a memory, and instructions stored in the memory, where the instructions, when executed by the processor, implement one or more of the methods described herein. Another example includes a computer-readable storage storing computer instructions, where the computer instructions, when run, perform one or more of the methods described herein.

Embodiments of the present disclosure are described in more detail hereinafter with reference to the drawings. However, these teachings may be embodied in many different forms and are not limited to the embodiments illustrated herein. Rather, these embodiments are provided to make the present disclosure thorough and complete and fully convey the scope of the concepts to those skilled in the art. Throughout the preceding description and the drawings, like reference numerals refer to like elements.

Although terms such as first and second may be used herein to describe elements or operations, these elements or operations are not to be limited by these terms. These terms are only used to distinguish one element or operation from another. For example, a first feature may be referred to as a second feature, and similarly, the second feature may be referred to as the first feature.

The terms used herein are intended to describe particular embodiments and not to limit the concept of the present disclosure. As used herein, unless otherwise clearly indicated in the context, a singular form “a”, “one” or “the” includes a plural form. The term “including” or “comprising” used in the specification specifies the existence of the described features, regions, parts, steps, operations, elements and/or components, without excluding the existence or addition of one or more other features, regions, parts, steps, operations, elements, components and/or combinations thereof.

Unless otherwise defined, all the terms (including technical and scientific terms) used herein have the same meanings as those commonly understood by those skilled in the art to which the present disclosure pertains. It is to be further understood that terms, such as those defined in commonly used dictionaries, are to be interpreted as having meanings consistent with their meanings in the context of the related art and/or the present disclosure and are not to be interpreted in an idealized or overly formal sense unless expressly so defined herein.

Embodiments of the teachings of the present disclosure are described in more detail hereinafter in conjunction with the drawings and implementations.

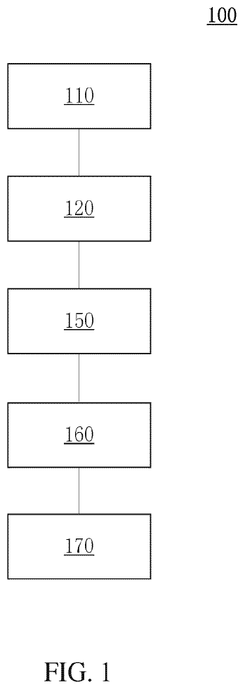

FIG. 1 shows an example method 100 for simulating deployment for an AI model incorporating teachings of the present disclosure. As shown in FIG. 1, the method for simulating deployment for an AI model includes the following:

Step 110: Determine at least two formats of an AI model. A format of the AI model is converted when at least one runtime is unable to run the format of the AI model, to obtain the at least two formats of the AI model. For example, an AI model is an AI model in a Keras format obtained through training in a Keras framework, and a corresponding Keras runtime is able to run the AI model in the Keras format. However, an open neural network exchange (ONNX) runtime is unable to run the AI model in the Keras format, and the AI model in the Keras format needs to be first converted into that in the ONNX format to be run in the ONNX runtime. Therefore, if the AI model is the AI model in the Keras format, and when preset runtimes include the Keras runtime and the ONXX runtime, a format of the AI model needs to be converted once to obtain two formats. Optionally, the AI model obtained through training may be selected from various commercially available models.

Step 120: Determine runtimes corresponding to the AI model in the at least two formats. Generally, the AI model is unable to be run directly on a target computing device, but needs to be run by using a corresponding runtime. That is, the runtime provides an environment in which the AI model runs on the target computing device. For example, a runtime corresponding to the AI model in the Keras format is determined as the Keras runtime, and a runtime corresponding to the AI model in the ONNX format is determined as the ONNX runtime.

In some embodiments, after step 120, the method further includes: virtualizing an actual computing device of a user and mounting the virtualized computing device to the preset simulation environment.

In some embodiments, the actual computing device of the user such as a desktop device or an edge device is virtualized, the virtualized computing device is mounted to a simulation environment in a cloud server by using a gateway technology, and hardware parameters of the virtualized edge device are kept consistent with that of an actual edge device, so that a simulation effect can be close to an effect that the actual edge device runs, to achieve similar performance.

Step 150. Combine a preset simulation environment with at least two runtimes to obtain at least two combinations. The preset simulation environments may further include at least one of the following: Edge-based X86 architecture emulator; NPU-based ARM architecture emulator; Generic X86 architecture environment without GPU; and Generic X86 architecture environment with GPU.

Step 160: Run the at least two combinations to obtain corresponding data flow results. When the preset simulation environment is Generic X86 architecture environment without GPU, AI models in the Keras runtime and the ONNX runtime are separately run in the foregoing simulation environment, to output corresponding data flows, and the data flows are quantified, to obtain data flow results. In some embodiments, the data flows are quantified in different manners, such as quantifying a running speed, and quantifying whether there is a capacity of running a corresponding AI model.

Step 170: Determine one combination from the at least two combinations according to the data flow results. In some embodiments, according to a preset sorting rule of the data flow results, for example, if a combination with the fastest running speed is outputted preferentially, the combination with the fastest running speed is determined in the obtained at least two combinations and outputted to the user. In some embodiments, data flow results of all the combinations are presented to the user, and according to a data flow result selected by the user, a corresponding combination is determined and outputted to the user.

By combining a preset simulation environment with a plurality of runtimes and an AI model in corresponding formats, according to corresponding data flow results, a better combination is provided to a user, to help the user quickly and effectively complete simulated deployment for the AI model.

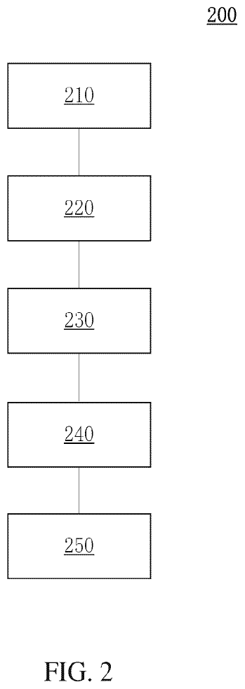

FIG. 2 shows an example method 200 for simulating deployment for an AI model incorporating teachings of the present disclosure. As shown in FIG. 2, the method for simulating deployment for an AI model includes the following:
Step 210: Determine at least one format of an AI model.
Step 220: Determine a runtime corresponding to the AI model in the at least one format.
Step 230: Combine at least two simulation environments with at least one runtime to obtain at least two combinations. The simulation environments include at least one of the following: a central processing unit (CPU) or a graphic processing unit (GPU). Because cloud providers often provide only virtualization services based on hardware, which cannot cover the virtualization of various edge devices, different CPU architectures and different GPU architectures are virtualized, to expand virtualization on a cloud, to provide more and richer simulation environments.
Step 240: Run the at least two combinations to obtain corresponding data flow results.
Step 250: Determine one combination from the at least two combinations according to the data flow results. In some embodiments, according to a preset sorting rule of the data flow results, for example, if a combination with the fastest running speed is outputted preferentially, the combination with the fastest running speed is determined in the obtained at least two combinations and outputted to the user. In some embodiments, data flow results of all the combinations are presented to the user, and according to a data flow result selected by the user, a corresponding combination is determined and outputted to the user.

In some embodiments, if the data flow result shows that a selected runtime is not compatible with a computing architecture in a selected simulation environment, step 210 to step 250 are cyclically performed until a data flow result shows that compatibility between a selected combination is achieved.

In some embodiments, if the data flow result shows that excessive resources of the selected simulation environment are occupied during running of the combination, or the data flow result is abnormal because a limitation of the selected simulation environment is exceeded, step 210 to step 250 are cyclically performed until a data flow result is normal when being displayed. By combining a plurality of simulation environments with at least one runtime and an AI model in a corresponding format, according to corresponding data flow results, a better combination is provided to the user, to help the user quickly and effectively complete simulated deployment for the AI model.

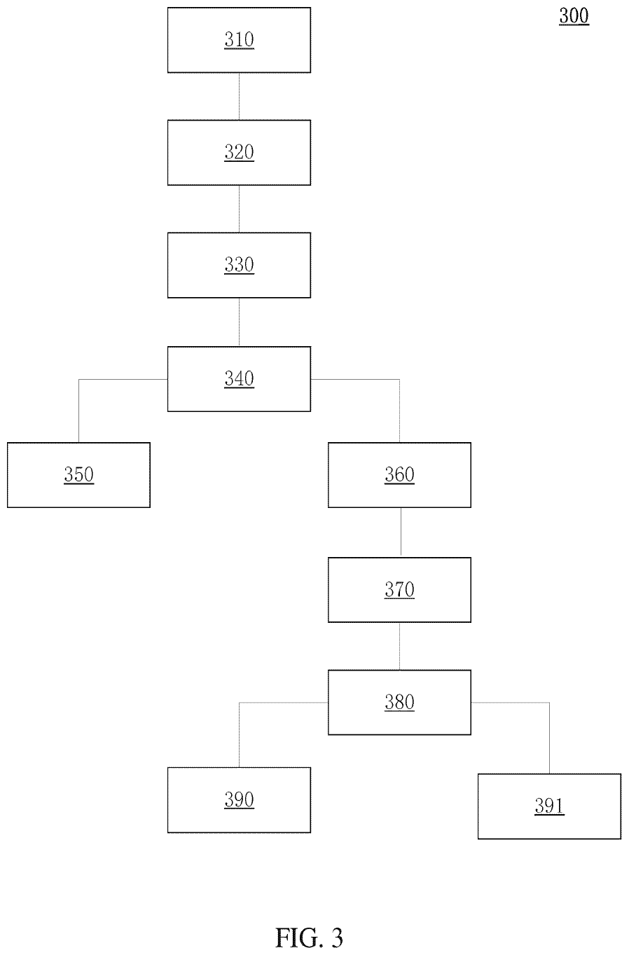

FIG. 3 shows an example method 300 for simulating deployment for an AI model incorporating teachings of the present disclosure. As shown in FIG. 3, the method for simulating deployment for an AI model includes the following:
Step 310: Determine a plurality of preset formats of an AI model.
Step 320: Determine a first runtime corresponding to the AI model in a first preset format in the plurality of preset formats.
Step 330: Perform a combination of a preset simulation environment and the first runtime.
Step 340: Run the combination to obtain a first data flow result.
Step 350: If the first data flow result meets a preset condition, output the combination.
Step 360: If the first data flow result does not meet the preset condition, determine a second runtime corresponding to the AI model in a second preset format in the plurality of preset formats.
Step 370: Perform a combination of the preset simulation environment and the second runtime.
Step 380: Run the combination to obtain a second data flow result.
Step 390: If the second data flow result meets the preset condition, output the combination.
Step 391: If the second data flow result does not meet the preset condition, perform similar step 360 to step 380 by using the AI model in a third preset format until a data flow result meets the preset condition, and outputting a combination corresponding to the data flow result.

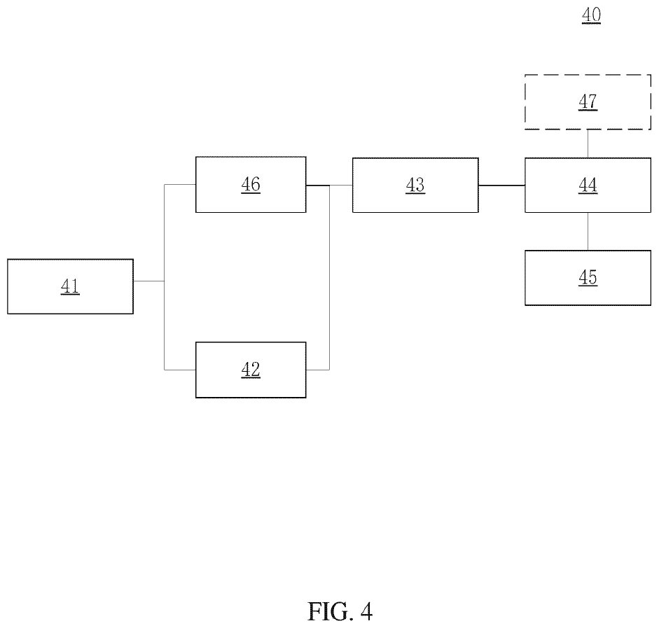

FIG. 4 shows an example apparatus for simulating deployment for an AI model incorporating teachings of the present disclosure. As shown in FIG. 4, the apparatus for simulating deployment for an AI model is deployed in a cloud infrastructure, and includes a converter 41, a runtime manager 42, a combinator 43, a profiler 44, a deployer 45, a computing device manager 46, and a monitor 47.

The converter 41 is configured to determine at least two formats of an AI model. A format of the AI model is converted when at least one runtime is unable to run the format of the AI model, to obtain the at least two formats of the AI model.

The runtime manager 42 is configured to determine a runtime corresponding to the AI model in the at least one format. In some embodiments, according to the received format of the AI model, a corresponding runtime is found from a cloud runtime node, and after being temporarily stored, the runtime is sent to the combinator 43.

The computing device manager 46 is configured to manage simulation environments, that is, manage different virtualized computing devices.

The combinator 43 is configured to combine at least two simulation environments with at least one runtime to obtain at least two combinations.

The profiler 44 is configured to run the at least two combinations, to output corresponding data flows, and obtain corresponding data flow results by quantifying the data flows. The data flow results are sent to the monitor 47, so that the user can intuitively learn different data flow results by using the monitor 47. In some embodiments, the data flow results include simulation process data, simulation result data, and running data of virtualized computing devices.

The deployer 45 is configured to determine one combination from the at least two combinations according to the data flow results. In some embodiments, according to a preset sorting rule of the data flow results, for example, if a combination with the fastest running speed is outputted preferentially, the combination with the fastest running speed is determined in the obtained at least two combinations and outputted to the user. In some embodiments, data flow results of all the combinations are presented to the user by using the monitor 47, and according to the data flow result selected by the user, a corresponding combination is determined and outputted to the user.

The present disclosure includes end-to-end solutions for the user, provides a cloud computing service, and provides a complete platform for the user, which is used for developing, running, and managing applications, and the user does not need to construct and maintain the platform on site, thereby greatly saving time of the user, and improving the efficiency of performing AI model deployment by the user, so that the present invention achieves flexibility and easy operability.

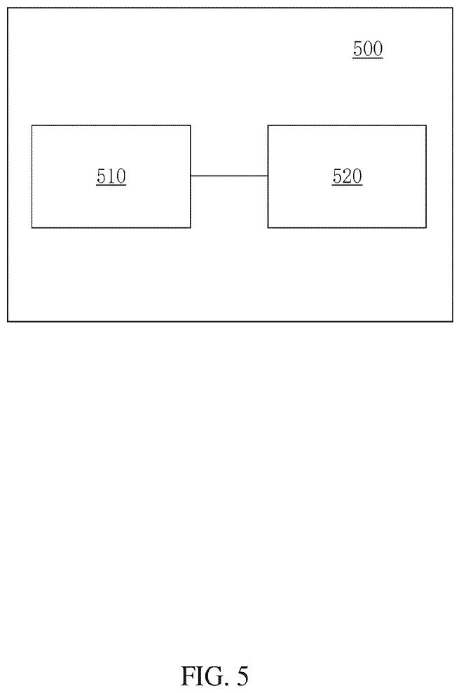

FIG. 5 is a schematic diagram of an example electronic device 500 incorporating teachings of the present disclosure. As shown in FIG. 3, the electronic device 500 includes a processor 510 and a memory 520. The memory 520 stores instructions, where the instructions are executed by the processor 510 to implement the method 100 described above, or to perform the method 200 described above, or to perform the method 300 described above.

Some embodiments include a computer-readable storage medium, storing computer instructions, where the computer instructions, when executed, perform the method 100 described above, or perform the method 200 described above, or perform the method 300 described above. The storage medium includes a volatile or nonvolatile medium or a removable or non-removable medium implemented in any method or technology for storing information (such as computer-readable instructions, data structures, computer program modules or other data). The storage medium include, but are not limited to, a random-access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storages, a magnetic cassette, a magnetic tape, a magnetic disk or other magnetic storage devices, or any other medium that can be used for storing desired information and that can be accessed by a computer.

If not in collision, the technical features in one embodiment may be combined with another and used in one embodiment. Each example embodiment is merely an implementation of the teachings of the present disclosure. Some or all steps of the preceding methods and function modules/units in the preceding system or apparatus may be implemented as software (which may be implemented by computer program codes executable by a computing device), firmware, hardware and suitable combinations thereof. In the hardware implementation, the of division the preceding function modules/units may not correspond to the division of physical components. For example, one physical component may have multiple functions, or one function or step may be performed jointly by several physical components. Some or all physical components may be implemented as software executed by a processor such as a central processing unit, a digital signal processor or a microprocessor, may be implemented as hardware, or may be implemented as integrated circuits such as application-specific integrated circuits.

Communication media generally include computer-readable instructions, data structures, computer program modules, or other data in carriers or in modulated data signals transported in other transport mechanisms and may include any information delivery medium. Therefore, the present application is not limited to any particular combination of hardware and software.

The above is a more detailed description of embodiments of the present invention in conjunction with implementations and is not to be construed as limiting embodiments of the present application. For those having ordinary skill in the art to which the present application pertains, simple deductions or substitutions may be made without departing from the concept of the present application and are considered to fall within the scope of the present application.

What is claimed is:

1. A method for simulating deployment for an artificial intelligence (AI) model, the method comprising:
determining at least two formats of an AI model;
determining runtimes corresponding to the AI model in the at least two formats;
combining a preset simulation environment with the at least two runtimes to obtain at least two combinations;
running the at least two combinations to obtain corresponding data flow results; and
determining one combination from the at least two combinations according to the data flow results.

2. The method according to claim 1, wherein determining a format of an AI model comprises
converting a format of the AI model when at least one runtime is unable to run the format of the AI model.

3. The method according to claim 1, further comprising, before the combining a preset simulation environment with at least two runtimes,
after an actual computing device of a user is virtualized, mounting the virtualized computing device to the preset simulation environment.

4. A method for simulating deployment for an artificial intelligence (AI) model, the method comprising:
determining at least one format of an AI model;
determining a runtime corresponding to the AI model in the at least one format;
combining at least two simulation environments with the at least one runtime to obtain at least two combinations;
running the at least two combinations to obtain corresponding data flow results; and
determining one combination from the at least two combinations according to the data flow results.

5. The method according to claim 4, wherein determining one combination from the at least two combinations according to the data flow results comprises
determining the one combination from the at least two combinations according to a preset sorting rule of the data flow results.

6. The method according to claim 4, wherein determining one combination from the at least two combinations according to the data flow results comprises
determining the one combination from the at least two combinations according to a data flow result selected by a user.

7. The method according to claim 4, wherein the simulation environments comprise at least one of the following:
a central processing unit (CPU) or a graphic processing unit (GPU).

8. A method for simulating deployment for an artificial intelligence (AI) model, the method comprising:
determining a plurality of preset formats of an AI model;
determining a first runtime corresponding to the AI model in a first preset format in the plurality of preset formats;
performing a combination of a preset simulation environment and the first runtime;
running the combination to obtain a first data flow result;
if the first data flow result meets a preset condition, outputting the combination; if the first data flow result does not meet the preset condition,
determining a second runtime corresponding to the AI model in a second preset format in the plurality of preset formats;
performing a combination of the preset simulation environment and the second runtime; and
running the combination to obtain a second data flow result;
if the second data flow result meets the preset condition, outputting the combination; and
if the second data flow result does not meet the preset condition, repeating the process until a data flow result meets the preset condition, and outputting a combination corresponding to the data flow result.

9. An apparatus for simulating deployment for an artificial intelligence (AI) model, the apparatus comprising:
a converter to
determine at least two formats of an AI model;
a runtime manager to
determine a runtime corresponding to the AI model in the at least one format;
a computing device manager to
manage simulation environments;
a combinator to
combine at least two simulation environments with at least one runtime to obtain at least two combinations;
a profiler to
run the at least two combinations to obtain corresponding data flow results; and
a deployer to
determine one combination from the at least two combinations according to the data flow results.

10. An electronic device comprising:
a processor; and
a memory storing instructions;
wherein the instructions are executed by the processor to: determine at least two formats of an AI model;
determine runtimes corresponding to the AI model in the at least two formats;
combine a preset simulation environment with the at least two runtimes to obtain at least two combinations;
run the at least two combinations to obtain corresponding data flow results; and
determine one combination from the at least two combinations according to the data flow results.

11. (canceled)
